(19) United States
(12) Patent Application Publication
(10) Pub. No.: US 2024/0164551 A1
(43) Pub. Date: May 23, 2024

(54) CONNECTING STRUCTURE OF DISPLAY RACK

(71) Applicant: JIREE (HUA'AN) TECHNOLOGY CO., LTD., Zhangzhou City (CN)

(72) Inventors: Xiaodong Li, Zhangzhou City (CN); Shuangbing Li, Zhangzhou City (CN); Xian Chen, Zhangzhou City (CN); Dadong Su, Zhangzhou City (CN)

(21) Appl. No.: 18/098,700

(22) Filed: Jan. 19, 2023

(30) Foreign Application Priority Data
Nov. 17, 2022 (CN) 202223058484.4

(51) Int. Cl. A47F 5/00

(52) U.S. Cl. CPC A47F 5/0056

(57) ABSTRACT

A connecting structure of a display rack includes an elbow connector, a locking member, and a transverse rod. At least one side of the elbow connector has a protruding portion. One end face of the protruding portion has a locking hole. The locking member is connected to the end face of the protruding portion. One end face of the locking member, facing the protruding portion, has a locking portion. The locking portion is rotatably connected to the locking hole. One end of the transverse rod is fitted on the locking member and is fixedly connected to the locking member. The display rack has a simple structure and is easy for installation.

### BACKGROUND OF THE INVENTION

### 1. Field of the Invention

The present invention relates to a display rack, and more particularly to a connecting structure of a display rack.

### 2. Description of the Prior Art

Display racks are mainly used in convenience stores, supermarkets, shopping malls, exhibitions and other places for displaying articles.

In general, a conventional display rack is composed of a frame body, partition plates, side plates, and a display plate. The frame body consists of several transverse rods and upright posts. The ends of the transverse rod and the upright post are connected by an elbow connector. The transverse rod, the upright post and the elbow connector are all connected by plugging. Generally, the ends of the transverse rod and the upright post are tightly fitted on the protruding portions of the elbow connector, so as to complete the assembly of the display rack. When all the transverse rods and the upright posts are connected by the elbow connecters to form the frame body, the frame body keeps its shape by means of the tight fit between the parts, without other restricting structures. Once the connection of any one of the elbow connectors and the transverse rod/the upright post is loosened due to external factors, the stability of the entire frame body will become poor, or even fall apart. As to a large-sized display rack, the parts of the conventional display rack are large in size, which increases the transportation cost and increases the difficulty of installation for end consumers.

### SUMMARY OF THE INVENTION

The primary object of the present invention is to provide a connecting structure of a display rack, which has an axial restriction effect on the rods of the display rack, especially on the transverse rod, so as to improve the connection stability and further increase the strength of the display rack. The display rack has a simple structure and is easy for installation. The display rack can be disassembled into parts and assembled by end consumers themselves, so as to reduce transportation costs and installation difficulties for end consumers.

In order to achieve the above object, the present invention adopts the following technical solutions:

A connecting structure of a display rack comprises an elbow connector, a locking member, and a transverse rod. At least one side of the elbow connector has a protruding portion. One end face of the protruding portion has a locking hole. The locking member is connected to the end face of the protruding portion. One end face of the locking member, facing the protruding portion, has a locking portion. The locking portion is rotatably connected to the locking hole. One end of the transverse rod is fitted on the locking member and is fixedly connected to the locking member.

The locking hole is an elongate hole. The locking portion includes a restricting piece matched with the elongate hole and a rotating shaft connected between the restricting piece and the end face of the locking member.

Preferably, a long axis of the restricting piece is perpendicular to a long axis of the elongate hole.

Preferably, the end face of the protruding portion has a square receiving groove. The end face of the locking member has a platform. The platform has two right-angled corners and two rounded corners. The two right-angled corners are arranged diagonally on the platform. The two rounded corners are arranged diagonally on the platform. Parallel sides of the two right-angled corners are in clearance fit with side walls of the receiving groove. The locking hole is coaxially disposed with the receiving groove. The locking portion is coaxially disposed with the platform.

Preferably, a surface of the platform has a restricting hole. A bottom wall of the receiving groove has a restricting protrusion matched with the restricting hole. When the locking member is connected to the elbow connector, the restricting protrusion is engaged in the restricting hole.

The transverse rod is a hollow rod. A middle portion of the transverse rod has a rib. The rib has a screw hole extending axially. Another end face of the locking member, facing the transverse rod, is recessed to form a slot matched with the rib. The locking portion has a through hole extending axially. The through hole communicates with the slot. The rib is inserted in the slot, and a screw is inserted through the through hole and locked in the screw hole.

The connecting structure of the display rack further comprises a support member. The protruding portion is plural. The support member is fixedly connected to a joint between two of the protruding portions that are perpendicular to each other for supporting a partition plate of the display rack.

Preferably, the support member is locked on sides or the joint between the protruding portions by screws.

A mounting groove is formed on a surface of the elbow connector. The mounting groove is configured to mount a side plate of the display rack.
By adopting the above technical solutions, the present invention has the following technical effects:
   1. The locking member is disposed between the elbow connector and the transverse rod, and the transverse rod is fixedly connected to the locking member. The locking portion of the locking member is rotatably connected to the locking hole of the elbow connector, so that the transverse rod is indirectly, rotatably connected to the elbow connector. The locking portion and the locking hole have an axial restriction effect on the axial movement of the transverse rod relative to the elbow connector. After the display rack is assembled, the transverse rod and the locking member are restricted by the side plates, partition plates, etc. and cannot be rotated, which ensures the connection stability between the transverse rod and the elbow connector. The overall strength of the display rack is improved.
   2. The display rack provided by the present invention has a simple structure and is easy for installation. The display rack can be disassembled into parts and assembled by end consumers themselves, so as to reduce transportation costs and installation difficulties for end consumers.

### BRIEF DESCRIPTION OF THE DRAWINGS

FIG. 1 is a perspective view of the connecting structure according to a preferred embodiment of the present invention;

FIG. 2 is a first exploded view of the connecting structure according to the preferred embodiment of the present invention;

FIG. 3 is a second exploded view of the connecting structure according to the preferred embodiment of the present invention;

FIG. 4 is a top view of the connecting structure according to the preferred embodiment of the present invention;

FIG. 5 is a cross-sectional view taken along line A-A of FIG. 4;

FIG. 6 is a perspective view of another implementation of the elbow connector according to the preferred embodiment of the present invention; and

FIG. 7 is a perspective view of the display rack according to the preferred embodiment of the present invention.

### DETAILED DESCRIPTION OF THE PREFERRED EMBODIMENTS

Embodiments of the present invention will now be described, by way of example only, with reference to the accompanying drawings.

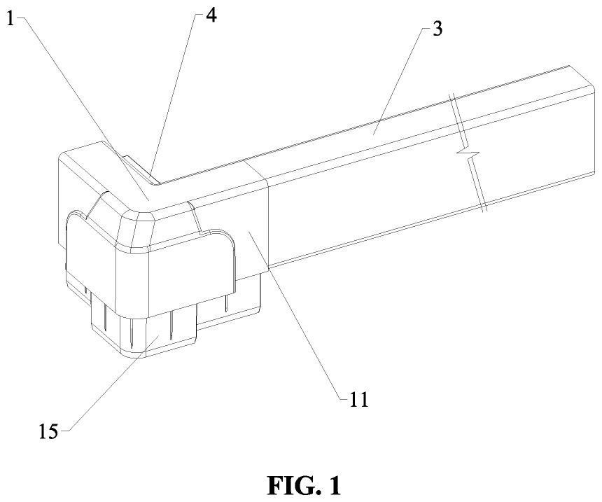

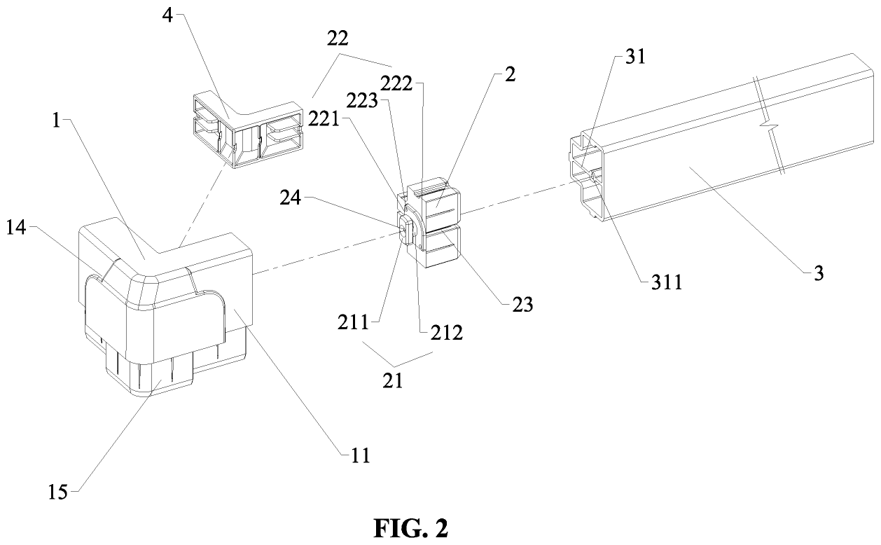

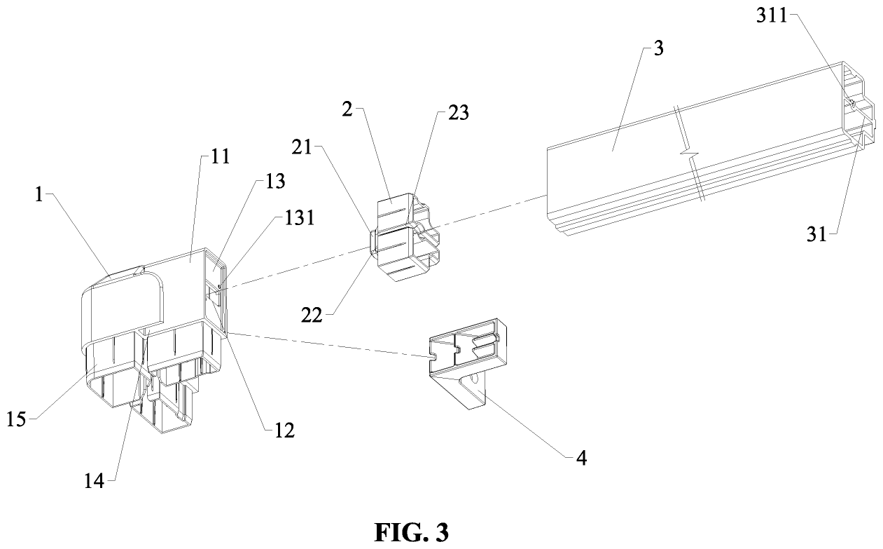

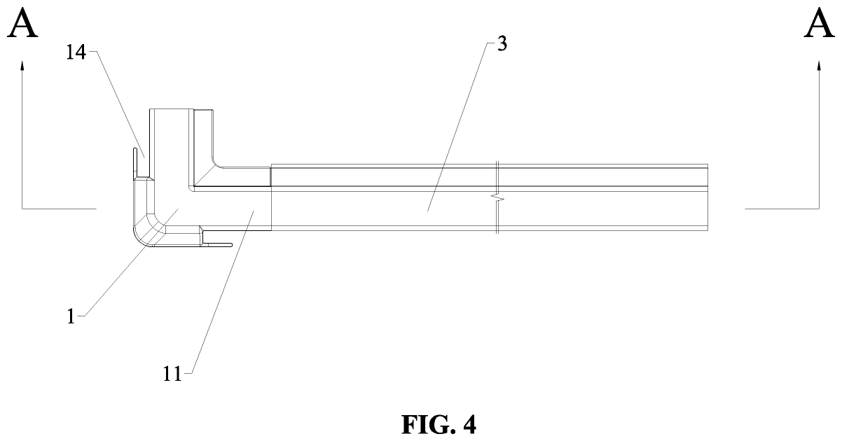

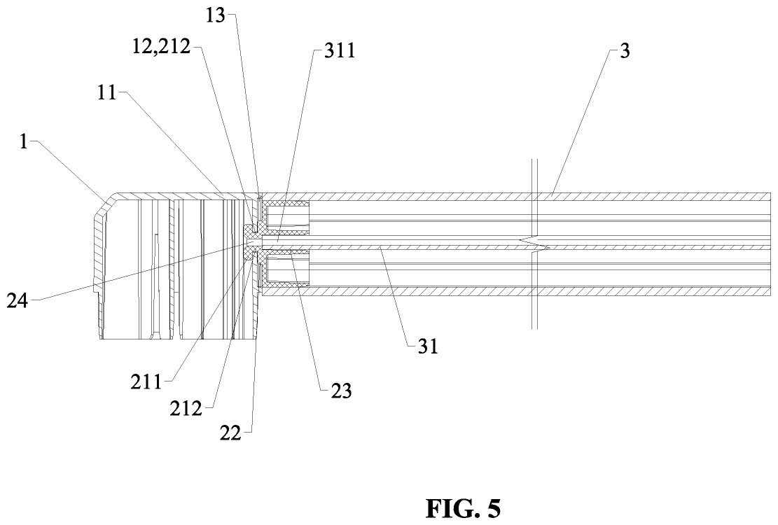

Referring to FIG. 1 through FIG. 6, the present invention discloses a connecting structure of a display rack, comprising an elbow connector 1, a locking member 2 and a transverse rod 3.

At least one side of the elbow connector 1 has a protruding portion 11. One end face of the protruding portion 11 has a locking hole 12.

The locking member 2 is connected to the end face of the protruding portion 11. One end face of the locking member 2, facing the protruding portion 11, has a locking portion 21. The locking portion 21 is rotatably connected to the locking hole 12.

One end of the transverse rod 3 is fitted on the locking member 2 and is fixedly connected to the locking member 2.

Specific embodiments of the present invention are shown below.

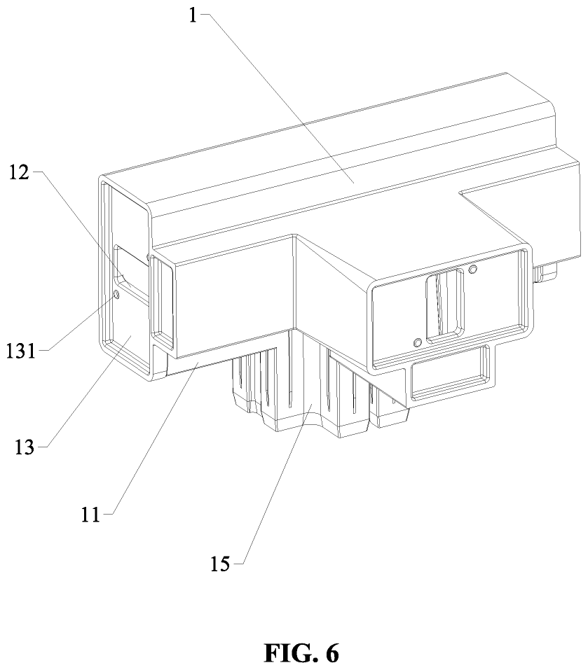

In this embodiment, two sides of the elbow connector 1 each have the protruding portion 11, that is, the elbow connector 1 of this embodiment are connected to two sets of locking members 2 and transverse rods 3. The elbow connector 1 is located at the corner of the display rack. FIG. 6 illustrates another implementation of the elbow connector 1. Three sides of the elbow connector 1 each have the protruding portion 11, which can be applied to a large-sized display rack. The elbow connector 1 can realize the connection of two rods arranged coaxially in the horizontal direction, so as to increase the length or width of the display rack.

The locking hole 12 is an elongate hole. The locking portion 21 includes a restricting piece 211 matched with the elongate hole and a rotating shaft 212 connected between the restricting piece 211 and the end face of the locking member 2. The restricting piece 211 of the locking member 2 is inserted into the locking hole 12 and then rotated a certain angle for installation, so that the restricting piece 211 and the locking hole 12 are interlaced, so as to achieve axial restriction on the locking member 2 relative to the elbow connector 1, that is, axial restriction on transverse rod 3 relative to the end face of the elbow connector 1.

Further, the long axis of the restricting piece 211 is perpendicular to the long axis of the elongate hole. The locking member 2 can be connected to or disconnected from the elbow connector 1 by rotating 90°.

The end face of the protruding portion 11 has a square receiving groove 13. The end face of the locking member 2 has a platform 22. The platform 22 has two right-angled corners 221 and two rounded corners 222. The two right-angled corners 221 are arranged diagonally on the platform 22. The two rounded corners 222 are arranged diagonally on the platform 22. The parallel sides of the two right-angled corners 221 are in clearance fit with the side walls of the receiving groove 13. The locking hole 12 is coaxially disposed with the receiving groove 13. The locking portion 21 is coaxially disposed with the platform 22. When the locking member 2 cooperates with the elbow connector 1, the rotating shaft 212 restricts the locking member 2 and the elbow connector 1 to only rotate in one direction. The rounded corner 222 restricts the locking member 2 and the elbow connector 1 to only rotate in another direction perpendicular to it. Under the restricting action of the rotating shaft 212 and the rounded corner 222, the locking member 2 and the elbow connector 1 are rotated coaxially. The right-angled corners 221 are configured to ensure that the locking member 2 is rotated in place, so as to ensure the reliability of the structure.

Furthermore, the surface of the platform 22 has a restricting hole 223, and the bottom wall of the receiving groove 13 has a restricting protrusion 131 matched with the restricting hole 223. When the locking member 2 is connected to the elbow connector 1, the restricting protrusion 131 is engaged in the restricting hole 223. The cooperation of the restricting hole 223 and the restricting protrusion 131 restricts the rotation of the locking member 2, thereby preventing the locking member 2 from shaking and loosening. After the locking member 2 is rotated in place, the user can know that the locking member 2 has been rotated in place so the user experience is better.

The transverse rod 3 is a hollow rod. The middle portion of the transverse rod 3 has a rib 31. The rib 31 has a screw hole 311 extending axially. The other end face of the locking member 2, facing the transverse rod 3, is recessed to form a slot 23 matched with the rib 31. The locking portion 21 has a through hole 24 extending axially. The through hole 24 communicates with the slot 23. The rib 31 is inserted in the slot 23. A screw is inserted through the through hole 24 and locked in the screw hole 311, so as to realize the connection of the locking member 2 and the transverse rod 3. The locking member 2 and the transverse rod 3 have higher connection strength and are detachable. The end of the transverse rod 3 covers the peripheral surface of the locking member 2, so that the locking member 2 is hidden in the transverse rod 3 to realize the seamless connection with the elbow connector 1. There are no obvious seams on the surface of the display rack, so the display rack is more beautiful.

The present invention further comprises a support member 4. When the elbow connector 1 has at least two protruding portions 11, the support member 4 is fixedly connected to the joint between the two protruding portions 11 that are perpendicular to each other for supporting a partition plate of the display rack.

Further, the support member 4 is locked on the sides or the joint between the protruding portions 11 by screws. A mounting groove 14 is formed on the surface of the elbow connector 1. The mounting groove 14 is configured to mount a side plate of the display rack, so as to realize the installation of the side plate. Specifically, the surface of the elbow connector 1 has an L-shaped structure. The L-shaped structure and the surface of the elbow connector 1 enclose the mounting groove 14. The opening of the mounting groove 14 faces outward.

The upper and lower surfaces of the elbow connector 1 each have a raised block 15 to be insertedly connected to the upright posts of the display rack.

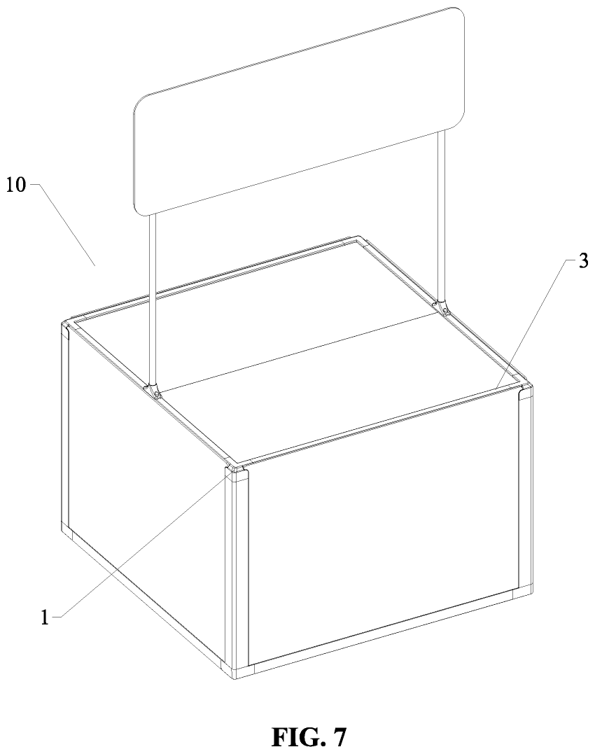

Referring to FIG. 7, the present invention further discloses a display rack 10 including the above connecting structure.

With the above solution, in the present invention, the locking member 2 is disposed between the elbow connector 1 and the transverse rod 3, and the transverse rod 3 is fixedly connected to the locking member 2. The locking portion 21 of the locking member 2 is rotatably connected to the locking hole 12 of the elbow connector 1, so that the transverse rod 3 is indirectly, rotatably connected to the elbow connector 1. The locking portion 211 and the locking hole 12 have an axial restriction effect on the axial movement of the transverse rod 3 relative to the elbow connector 1. After the display rack is assembled, the transverse rod 3 and the locking member 2 are restricted by the side plates, partition plates, etc. and cannot be rotated, which ensures the connection stability between the transverse rod 3 and the elbow connector 1. The overall strength of the display rack is improved. The display rack provided by the present invention has a simple structure and is easy for installation. The display rack can be disassembled into parts. The display rack is assembled by end consumers themselves to reduce transportation costs and installation difficulties for end consumers.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A connecting structure of a display rack, comprising an elbow connector, a locking member and a transverse rod;
at least one side of the elbow connector having a protruding portion, one end face of the protruding portion having a locking hole;
the locking member being connected to the end face of the protruding portion, one end face of the locking member, facing the protruding portion, having a locking portion, the locking portion being rotatably connected to the locking hole;
one end of the transverse rod being fitted on the locking member and being fixedly connected to the locking member.

2. The connecting structure of the display rack as claimed in claim 1, wherein the locking hole is an elongate hole; the locking portion includes a restricting piece matched with the elongate hole and a rotating shaft connected between the restricting piece and the end face of the locking member.

3. The connecting structure of the display rack as claimed in claim 2, wherein a long axis of the restricting piece is perpendicular to a long axis of the elongate hole.

4. The connecting structure of the display rack as claimed in claim 3, wherein the end face of the protruding portion has a square receiving groove; the end face of the locking member has a platform, the platform has two right-angled corners and two rounded corners, the two right-angled corners are arranged diagonally on the platform, the two rounded corners are arranged diagonally on the platform, parallel sides of the two right-angled corners are in clearance fit with side walls of the receiving groove; the locking hole is coaxially disposed with the receiving groove, and the locking portion is coaxially disposed with the platform.

5. The connecting structure of the display rack as claimed in claim 4, wherein a surface of the platform has a restricting hole, a bottom wall of the receiving groove has a restricting protrusion matched with the restricting hole, when the locking member is connected to the elbow connector, the restricting protrusion is engaged in the restricting hole.

6. The connecting structure of the display rack as claimed in claim 1, wherein the transverse rod is a hollow rod, a middle portion of the transverse rod has a rib, the rib has a screw hole extending axially; another end face of the locking member, facing the transverse rod, is recessed to form a slot matched with the rib, the locking portion has a through hole extending axially, the through hole communicates with the slot; the rib is inserted in the slot, and a screw is inserted through the through hole and locked in the screw hole.

7. The connecting structure of the display rack as claimed in claim 1, further comprising a support member, wherein the protruding portion is plural, the support member is fixedly connected to a joint between two of the protruding portions that are perpendicular to each other for supporting a partition plate of the display rack.

8. The connecting structure of the display rack as claimed in claim 7, wherein the support member is locked on sides or the joint between the protruding portions by screws.

9. The connecting structure of the display rack as claimed in claim 1, wherein a mounting groove is formed on a surface of the elbow connector, and the mounting groove is configured to mount a side plate of the display rack.
